(19) United States
(12) Patent Application Publication
(10) Pub. No.: US 2002/0020281 A1
(43) Pub. Date: Feb. 21, 2002

(54) Electromagnetic humbucker pick-up for stringed musical instruments

(76) Inventor: David George Devers, Melbourne (AU)

Correspondence Address: DAVID DEVERS, c/o Bob Wilson, 3905 West 190th Street, Stilwell, KS, 66085, US

(21) Appl. No.: 09/816,202

(22) Filed: Mar. 26, 2001

(30) Foreign Application Priority Data
May 17, 1999 (AU) PQO385
May 19, 2000 (AU) 35385100
May 23, 2000 (GB) GB 0012307.5

(51) Int. Cl. G10H 3/18

(52) U.S. Cl. 84/728

(57) ABSTRACT

An electromagnetic Humbucker Pick-up for stringed musical instruments is disclosed. The device is a former (7) with two coils of wire (3) & (4) wound on having a common axis perpendicular to a set of ferrous strings (13), the first coil of wire (3) is directly beneath the strings (13), the second coil of wire (4) is beneath the second coil of wire (3). Two permanent magnet means (1) & (2) generating opposing magnetic fields (5) & (6). The first permanent magnet means (1) is magnetically polarized in the opposite direction to that of the second permanent magnet means (2). The two permanent magnet means (1) & (2) are situated across and down the center of the former. (7) The first permanent magnet means (1) is in the center of the first coil of wire (3) and the second permanent magnet means (2) is in the center of the second coil of wire (4).

### BACKGROUND OF THE INVENTION

This invention relates to improvements in devices for picking up the sound from musical instruments and converting that sound into an electrical signal, otherwise known as a pick-up. (humbucker guitar pick-ups)

A single-coil pick-up consists of a magnet with a coil around it or a number of magnets with a coil around them.

1950's design type humbucker pick-ups consist of either a flat bar magnet with pole pieces that are magnetic flux conductors ie (ferrous screws or slugs) placed at right angles to the magnet, on each end of the bar magnet (on the south pole & on the north pole of the magnet, bringing a south pole & a north pole up to the strings,) there is a coil around the pole pieces on the south pole and a coil around the pole pieces on the north pole. These coils are connected out-of-phase thus cancelling electrical noise, they are also magnetically out-of-phase which puts the signal generated from the strings “string-signal”, back in-phase.

Another way is the double humbucker where two single-coil pick-ups with magnets through the centers of their coils, are placed right next to each other side by side, one with the south poles facing the strings and one with the north poles facing the strings. Again the coils are wired out-of-phase thus cancelling electrical noise but not the string-signal in the same way as the pick-up described above.

The split humbucking configuration type pick-up like that seen on some base guitars, consists of two pick-ups in one. One is placed under the E and A strings, the other half under the D and G strings, the two halves are wired out-of-phase (180 degrees) to cancel electrical noise.

There are some relatively new humbucker pick-ups using an “EMF-coil” eg a coil that is designed and situated as to pickup electro magnetic field waves EMF (hum) and not the “string-signal”, signals produced by the strings only. Placed next to a “string-coil” eg a coil that is designed to pickup both string-signal and EMF (hum).

One type the “active isolation blocking” type humbucker pick-up consists of a EMF-coil next to a signal-coil and two pre-amplifiers or buffers, the signal from the EMF-coil is fed to one pre-amplifier and the signal from the signal-coil is fed to the other pre-amplifier, then the output of the two pre-amplifiers is mixed together out-of-phase thus cancelling the electrical noise.

Another type the “passive isolation blocking” type humbucker pick-up consists of a EMF-coil next to a signal-coil the EMF-coil can be wired out-of-phase, in parallel or in series acting as a noise suppressive inductance or choke, in series or parallel with the signal-coil, as well as an out-of-phase electrical noise generator to reduce electrical noise.

The disadvantages and problems with all of these pick-ups are as follows.

An electro magnetic field “EMF” is generated by any thing & every thing electrical.

The disadvantage with a single-coil pick-up by it self is that electro magnetic field waves cutting across the pick-ups coil create electrical noise in the output of the pick-up.

The disadvantage with split humbucking configuration type pick-ups is that they will not work on six-string guitars because the strings are too close together. On a bass guitar there is not much interaction between the two halves ie the strings over half will not produce much of a signal in the other half, causing induction loading & some cancellation of harmonics.

The disadvantage with 1950's design type humbucker pick-ups & double humbucker type pickups.

Is that unlike single-coil pick-ups where the signal is picked up off the string from a single point, incorporating all of the harmonics. These humbucker pick-ups, pickup the signal over the length of the string where the magnetic field extends from one pole piece or magnet to the other. As the harmonics are out-of-phase at these two points they are suppressed dulling the sound. (anti-nodes & nodes problems)

The disadvantage with humbucking with passive isolation blocking is that EMF-coils pickup EMF & cancel hum & noise but do not pickup much signal from the string & any signal they do pickup from the string is out of phase to the signal coming from the signal-coil, to the signal coming from the string or the signal-coil, the EMF-coil is a loading inductance and affects the frequency response & dulls the sound. It is also difficult to create a low resistance low inductance EMF-coil with the same output as a signal-coil with magnets.

The disadvantage with humbucker pick-ups that use active isolation blocking with pre-amplifiers or buffers is that pre-amplifiers generate noise & pre-amplifiers are needed & batteries or power supplies are needed as well as the problems of matching the resonance of coils and the problems associated with the amplification or presence of an out-of-phase string-signal.

Another problem with both passive and active isolation blocking is that a ferrous metal plate placed between the signal-coils is necessary to isolate the EMF-coil from the signal-coil. This plate strengthens the magnetic flux and pulls on the guitar strings stopping them from sustaining. In pick-ups with separate magnets under each string the flux varies creating a shape & pattern, when a string is played and bent it moves through the flux pattern, changing the tone of the note. This plate also changes the shape of the magnetic flux making the flux more constant over and across the top of the pick-up thus reducing the change in tone as strings are bent.

### SUMMARY OF THE INVENTION

These problems associated with existing humbucker pick-ups and single-coil pick-ups are overcome by the present invention and are as follows.

The problems with single-coil pick-ups are overcome, as the present invention does not pickup hum and noise from external sources, as there are two coils connected out of phase to EMF.

The problems with the 1950's design type humbucker pick-up and the double humbucker pick-up are overcome as the present invention only picks up the signal from a single point on the string, incorporating far more harmonics in the output of the device. see FIGS. 3B, 3D & 3E. (Anti-node and node problems are therefore reduced)

The problems with split humbucking configuration type pick-ups are overcome as the present invention works on guitars as well as bass guitars and does not suffer from interaction and induction problems between the two coils, as both coils of the present invention pickup and generate a signal from any or all the strings. The problems with humbucker pick-ups like the active isolation blocking type are overcome as the present invention is of passive design and does not require pre-amplifiers or batteries.

The problems associated with both active and passive isolation blocking humbucking are overcome by the present invention and are as follows.

The problems with signal cancelling due to phase problems are overcome, as both coils of the present invention generate in phase string-signal.

The problems with dulling of the signal due to induction problems are overcome, as both coils of the present invention generate string-signal.

The problems with loss in sustain of a note played are overcome as the present invention does not require a ferrous metal isolation plate between the to coils that strengthens the magnetic flux.

The problems with loss of a change in tone when a string is bent and moved across the pick-up through the shape of the magnetic flux pattern are overcome, as the present invention does not require a ferrous metal isolation plate between the two coils that changes the shape of the magnetic flux pattern.

In effect the present invention approximates the characteristic sound of a single-coil pick-up with all the hum and noise cancelling of a humbucker pick-up.

### BRIEF DESCRIPTION OF THE INVENTION

To assist with understanding the invention reference will now be made to the accompanying drawings which show two examples of the invention.

The present invention is a electromagnetic Humbucker Pick-up for stringed musical instruments. The structure of the pick-up consists of a first permanent magnet means (1), with a first wire coil means (3) wound around thereof, disposed on top of a second permanent magnet means (2), with a second wire coil maens (4) wound around thereof, all held together with a former (7) thereof. See FIGS. 1A to 1G.

The magnetic polarization of the first permanent magnet means substantially opposes the magnetic polarization of the second permanent magnet means thereof.

The first permanent magnet means substantially generating a first magnetic field (5) thereof, and the second permanent magnet means substantially generating a second magnetic field (6) thereof. See FIGS. 2A, 2B & 2C.

The first permanent magnet means (1) and second permanent magnet means (2) are situated beneath ferrous strings (13) in a way that only the magnetic flux (5) of said first permanent magnet means (1) thereof, reaches out to the said strings (13). See FIGS. 3A, 3B, 3C, 3D & 3E.

The first said wire coil means and second said wire coil means having a common axis perpendicular to said strings (13) thereof.

Either or boath permanent magnet means may comprise a plural of permanent magnets arranged in spaced relationship to the strings.

Either or boath permanent magnet means may comprise a plural of permanent magnets having ferrous pole pieces disposed coaxial on either or both magnetic poles thereof, arranged in spaced relationship to the strings.

Either or boath permanent magnet means may comprise a plural of permanent magnets disposed in pairs with parallel axis thereof, arranged in spaced relationship to the strings.

Either or boath permanent magnet means may comprise a plural of permanent magnets having ferrous pole pieces disposed coaxial on either or both magnetic poles thereof, disposed in pairs with parallel axis thereof, arranged in spaced relationship to the strings.

Either or boath permanent magnet means may comprise a single permanent magnet elongated across the strings.

Either or boath permanent magnet means may comprise a single permanent magnet having a ferrous pole piece disposed on either or both magnetic poles thereof, elongated across the strings.

### PRINCIPALS OF OPERATION

A first permanent magnet means (1) generates a first magnetic field (5), a second permanent magnet means (2) generates a second magnetic field (6) the polarization of the first magnetic field (5) substantially opposes the polarization the second magnetic field (6) see FIGS. 1A, 1B, & 1C. The first magnetic field (5) is closest to the strings (13) and the second magnetic field (6) is furthest from the strings (13). See FIGS. 3A, 3B, 3C, 3D & 3E.

The first wire coil means (3) will now be referd to as first coil (3). The second wire coil means (4) will now be referd to as coil (4).

Strings (13) incorporate ferrous metal, when a vibrating string (13) cuts through the first magnetic field (5) a fluctuation is created in the first magnetic field (5) this fluctuation interacts with the second magnetic field (6) and the fluctuation is substantially relayed through into the second magnetic field (6). The fluctuation in the first magnetic field (5) interacts with the first Coil (3) and produces a alternating current in the first coil (3), the fluctuation in the second magnetic field (6) interacts with the second coil (4) and produces a alternating current in the second coil (4).

The first coil (3) and the second coil (4) can be wired out-of-phase with each other to EMF, either in series or parallel. see FIGS. 4A & 4B.

As first coils (3) is out-of-phase with second coil (4) to any external magnetic wave cutting across the pick-up, the EMF signals are cancelled out. As the polarization of the first magnetic field (5) opposes the polarization of the second magnetic field (6), the first coil (3) is in-phase with the second coil (4) to fluctuation in the first magnetic field (5) and the second magnetic field (6), the signal output of the pick-up is only that of the vibrating string.

Note that by using a different number of turns, a different gauge of wire, magnets of a different permeability & magnetic pole pieces of different permeability, in the upper section than those in the lower section of the pick, will give closer matching of string signal to EMF ratio in the outputs of the two coils, in order to optimize frequency characteristics of string-signal & EMF noise cancelling.

Note that any induction loading between the two coils may be eliminated with active circuits by feeding the output of each coil into separate inputs of a differential amplifier.

Note that three or four or more opposing permanent magnet means cascaded one or top of the other, creating three or four or more opposing magnetic fields, with an associated coil wound around each permanent magnet means, functioning in the same manner as the above is possible. And is deemed to be within the scope of this patent.

Note that the dimensional proportions of the device shown in the drawings are for a practical guide line and not the optimum proportions and that all dimensional proportions are deemed to be within the scope of this patent.

### FURTHER DESCRIPTION. OPTICAL EXTRAS.

To add to the performance and versatility of the pick-up the first coil (3) is tapped or divided in to a plural of coils & the second coil (4) is tapped or divided in to a plural of coils. See FIGS. 5A & 5B.

In doing this featchers are added to the pickup, such as two coil parallel humbucking, two coil series humbucking, single-coil pick-up & phase humbucking between two single-coil pick-ups, all with outputs that are matched to the same level.

The number of turns suitable for the available string-signal at the three pickup positions used on a guitar are as follows.

15000 (3) & (4) bridge position parallel humbucker.

12750 (3) & (4) middle position parallel humbucker.

12000 (3) & (4) neck position parallel humbucker.

7500 (3) & (4) bridge position series humbucker.

6375 (3) & (4) middle position series humbucker.

6000 (3) & (4) neck position series humbucker.

7500 (3) bridge position single-coil pick-up.

6375 (3) middle position single-coil pick-up.

6000 (3) neck position single-coil pick-up.

It is impractical to put all these taps & coils on just one pick-up therefore typical configurations are as follows.

Bridge Pick-up

First Coil (3) taps. 15000, 12750, 7500 turns.

Second Coil (4) divided into two coils 7500 turns each.

Middle Pick-up

First coil (3) taps. 12750, 12000, 6375 turns.

Second coil (4) divided into two coils 6375 turns each.

Neck Pick-up

First coil (3) taps. 12000, 6000 turns.

Second coil (4) divided into two coils 6000 turns each.

For a typical parallel humbucking configuration the tap for the maximum number of turns on first coil (3) is connected to ground and the other end connected to hot. The two coils in the second coil (4) are connected together in series forming a coil with the same number of turns as the first coil (3), this coil and the first coil (3) are connected in parallel, see FIG. 6A.

For a typical series humbucking configuration the center tap of the first coil (3) is connected to ground and either end connected to one of the coils in the second coil (4) the other end of this coil is connected to hot, see FIG. 6B. This configuration would mostly be utilized on the neck pickup eliminating the necessity for a division of the second coil (4) in the middle & bridge pick-ups.

For a single-coil pick-up only the first coil (3) is necessary, the center tap is connected to ground and either end is connected to hot, see FIG. 6C.

Parallel out-of-phase hubbucking between two single-coil pick-ups.

The middle pick-up is wound in the opposite direction or phase to the other pick-ups

For out-of-phase humbucking between bridge & middle pick-ups the 12750 turn tap on the first coil of the bridge pick-up is connected to ground and the other end to hot. The 12750 turn tap on the first coil of the middle pick-up is connected to ground and the other end to hot, see FIG. 6D.

For out-of-phase humbucking between middle & neck pick-ups the 12000 turn tap on the first coil of the middle pick-up is connected to ground and the other end to hot. The 12000 turn tap on the first coil of the neck pick-up is connected to ground and the other end to hot, see FIG. 6E.

Note that values of the number of turns listed for each coil of wire in the device are practical values and that grater values and lesser values perform equally as well as those values listed and that all values of numbers of turns are deemed to be within the scope of this patent.

### DETAILED DESCRIPTION OF THE INVENTION

In one form of the invention former (7) is fabricated with holes (21) in a row across the middle & down through the center See FIG. 7A. The former (7) is fabricated with a upper cavity (19) & a lower cavity (20), each of the cavities extends a full circle around the sides & ends of the Former (7), see FIGS. 7B & 7C.

Coil (3) is wound into the cavity (19) & Coil (4) is wound into the cavity (20) see FIG. 7G. The former & coils are then dipped and soaked in mildly heated wax and allow to cool.

Then the magnets (1) & (2) are pressed into the holes (21) with light pressure, see FIGS. 7C & 7D. If the former is strong and the tolerances are fine then the magnets (1) & (2) can be pressed out again if necessary

Another form of the invention consists of two formers (14) & (15) with magnets (1) & (2) firmly attached (glued) inside and the two formers are screwed together tightly, with brass screws (17) & nuts (16) see FIGS. 8A & 8B.

In yet another form of the invention rare earth magnets (1) & (2) with opposing poles are held against each other (sandwiched together) by pole pieces (8) & (9) made out of ferrous metal, the pole pieces have threads on them and screw in to the former (7) on each side see FIGS. 9A and 9B. The pole pieces and magnets have coils (3) & (4) around them see FIG. 9C.

For simplicity of manufacture magnets and pole pieces with out threads may be glued or pressed in to the former. The magnets (1) & (2) may also be made of any other permanent magnet type.

There may be an advantage in using rare earth magnets in that they stay magnetised longer, although they will give a slightly different sound than alnico magnets, as the shape of the magnetic flux is slightly different. The life of the magnets may be improved by placing more pole pieces (11) & (12) between the magnets see FIGS. 10A & 10B.

Another method is to construct the tubular sections (18) of the former (7) out of thin brass or some other non-ferrous metal. Threads are taped into the tubular sections of the former so that the magnets or magnets and pole pieces can be screwed in tightly. see FIGS. 11. Alternatively the magnets, or the magnets could be pressed or glued in to the tubular sections. (This method adds on interesting metal sound to the device although it does lose a few dB of output.) The tubular sections (18) may also be constructed of Nylon pressure tube or similar material.

Another form of the invention with only two permanent magnets there is a slot (21) through the center of former (7) were the permanent magnets (1) & (2) are pressed in to the former see FIG. 12B & 12E. And there are coils wound in to the cavities (19) & (20) of the former (7). See FIGS. 12A & 12E.

In a similar form of the invention with only two magnets there is a ferrous pole pieces (9) & (11) disposed coaxial at each magnetic pole of permanent magnets (1) and ferrous pole pieces (12) & (8) disposed coaxial at each magnetic pole of permanent magnets (2), that are pressed in to former (7) see FIGS. 12D & 12E.

there are coils of wire would in to the cavities (19) & (20) of the former (7). See FIGS. 12A & 12E.

The former or formers are made of teflon, plastic, fibreglass, paxolin, fiberboard or similar material. The magnets are made of alnico magnets, rare earth magnets or any other type of permanent magnet. The coils are made of copper wire or some other non-ferrous wire.

A typical magnetic strength at the top surface of the device is approximately 700 gauss.

Whatever method of construction is preferred the magnets must be held extremely tight and rigid. The complete device must be extremely rigid so that no component can vibrate and the windings must be as tight as possible. Any vibrating components in the device will be reflected in the output as acoustic pickup and not magnetic pickup. Other methods of construction of the configuration of this device are deemed to be within the scope of this invention.

### BRIEF DESCRIPTION OF THE DRAWINGS

Note that a permanent magnet means is referred to as magnets or as magnets plus pole pieces.

Drawings on page 1.

The figures and text on page 1, illustrates a brief summary of the invention.

Drawings on page 2.

FIG. 1A, illustrates a Top view of the case that fits over the former (7), coils (3) & (4) and magnets (1) & (2).

FIG. 1B, illustrates a side view of the case over the former (7), coils (3) & (4) and magnets (1) & (2).

FIG. 1C, illustrates a side view of the former (7) with the magnets (1) & (2) inserted and the coils (3) & (4) around the former (7).

FIG. 1D, illustrates a top view of the former (7).

FIG. 1E, illustrates a side view of the former (7) with the magnets (1) & (2) above.

FIG. 1F, illustrates a technical type representation of the coils (3) & (4) around the magnets (1) & (2).

FIG. 1G, illustrates magnets (1) & (2) with magnetic fields (5) & (6).

Drawings on page 3.

FIG. 2A, illustrates the magnetic field (5) generated by magnet (1) opposing the magnetic field (6) generated by magnet (2).

FIG. 2B, illustrates three dimensionaly magnet (1) sandwiched against magnet (2) and their opposing magnetic fields (5) & (6).

FIG. 2C, illustrates a technical type representation of the coils (3) & (4) around the magnets (1) & (2).

FIG. 2D, illustrates magnets (1) & (2) with magnetic fields (5) & (6).

Drawings on page 4.

FIG. 3A, illustrates a technical type representation of magnets (1) & (2), magnetics fields (5) & (6) and coils (3) & (4).

FIG. 3B, illustrates a side view.

FIG. 3C, illustrates a set of strings (13) with pairs of magnets (1) & (2) disposed beneath.

FIG. 3D, is one pair of magnets (1) & (2) with associated magnetic fields (5) & (6) disposed beneath one string (13).

FIG. 3E, shows magnets (1) & (2) with associated magnetic fields (5) & (6) disposed beneath strings (13).

Drawings on page 5.

FIG. 4A, illustrates a circuit diagram representation of the device wherein the coils (3) & (4) are connected in parallel.

FIG. 4B, illustrates a circuit diagram representation of the device wherein the coils (3) & (4) are connected in series.

FIG. 4C, illustrates a technical type representation of either of the coils (3) or (4).

Drawings on page 6.

FIGS. 5A & 5B, illustrates some of the optional configurations for the coils (3) and (4).

FIG. 5A, is a circuit diagram representation of a device with a tapped coil (3).

FIG. 5B, is a circuit diagram representation of a device with a tapped coil (3) & a divided coil (4).

Drawings on page 7.

FIGS. 6A to 6E, illustrats circuit diagrams of various pick-up configurations.

FIG. 6A, parallel humbucking.

FIG. 6B, series humbucking.

FIG. 6C, single coil pick-up.

FIG. 6D, out-of-phase humbucking between bridge & middle pick-ups.

FIG. 6E, out-of-phase humbucking between middle & neck pick-ups.

Drawings on page 8.

FIG. 7A, illustrates a top view of the former (7).

FIG. 7B, illustrates a end view of the former (7).

FIG. 7C, illustrates a side view of the former (7) with the magnets (1) & (2) above.

FIG. 7D, illustrates a side view of the former (7) with the magnets (1) & (2) inserted.

FIG. 7E, illustrates a Top view of the case that fits over the device.

FIG. 7F, illustrates a side view of the case that fits over the device.

FIG. 7G, illustrates a side view of the former (7) with the magnets (1) & (2) inserted and the coils (3) & (4) around the former (7).

Drawings on page 9

FIGS. 8A & 8B, illustrates a method of construction wherein the former is in two sections (14) & (15).

FIG. 8A, shows the two sections disassembled.

FIG. 8B, shows the two sections assembled.

Drawings on page 10.

FIG. 9A, illustrates a side view of the former (7), with the magnets (1) & (2) plus pole pieces (9) & (8) above.

FIG. 9B, illustrates a side view of the former (7), with the magnets (1) & (2) plus pole pieces (9) & (8) inserted.

FIG. 10A, illustrates a side view of the former (7), with the magnets (1) & (2) plus pole pieces (9),(8),(11) & (12) above.

FIG. 10B, illustrates a side view of the former (7), with the magnets (1) & (2) plus pole pieces (9),(8),(11) & (12) inserted.

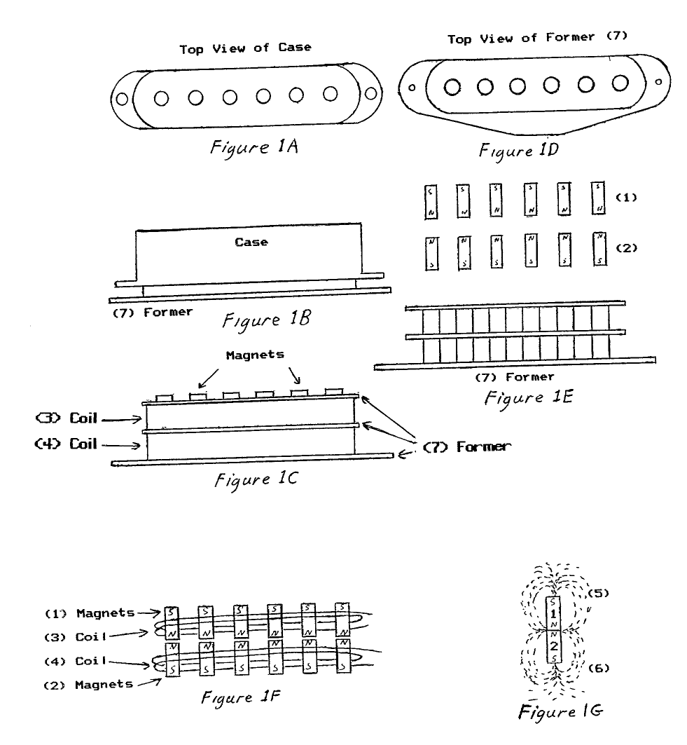

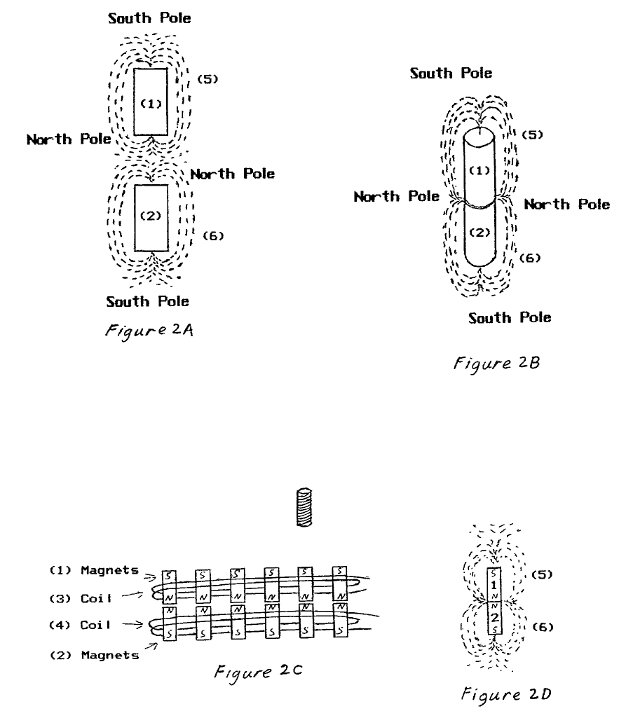

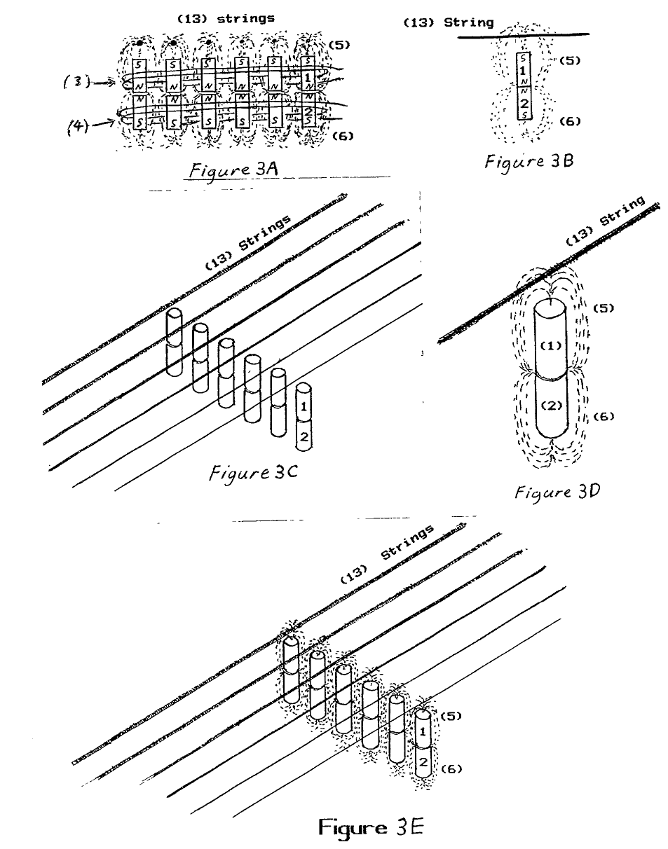

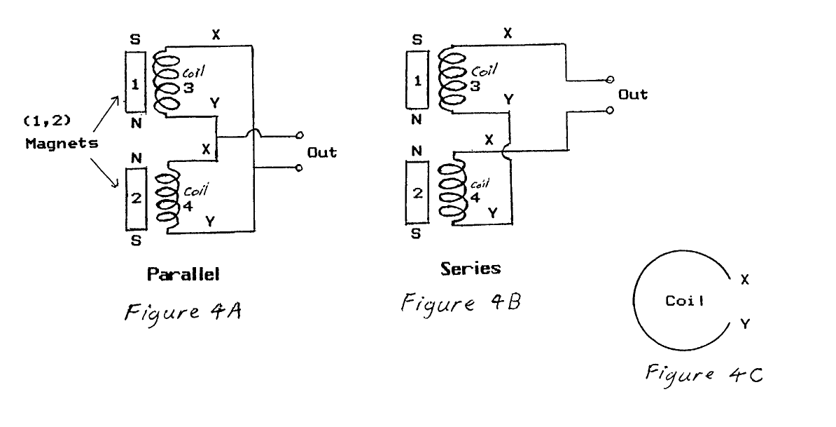

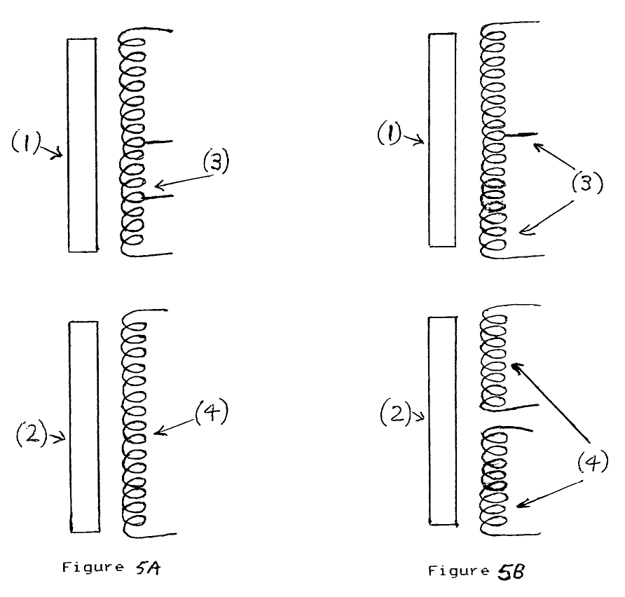

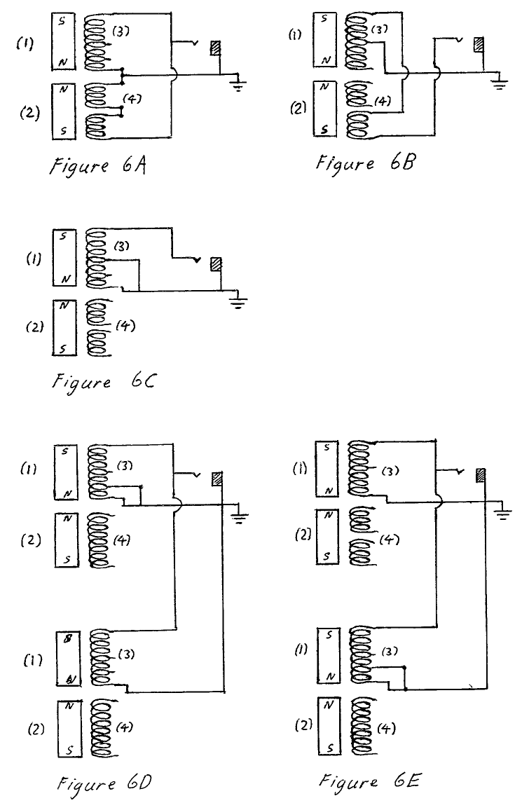

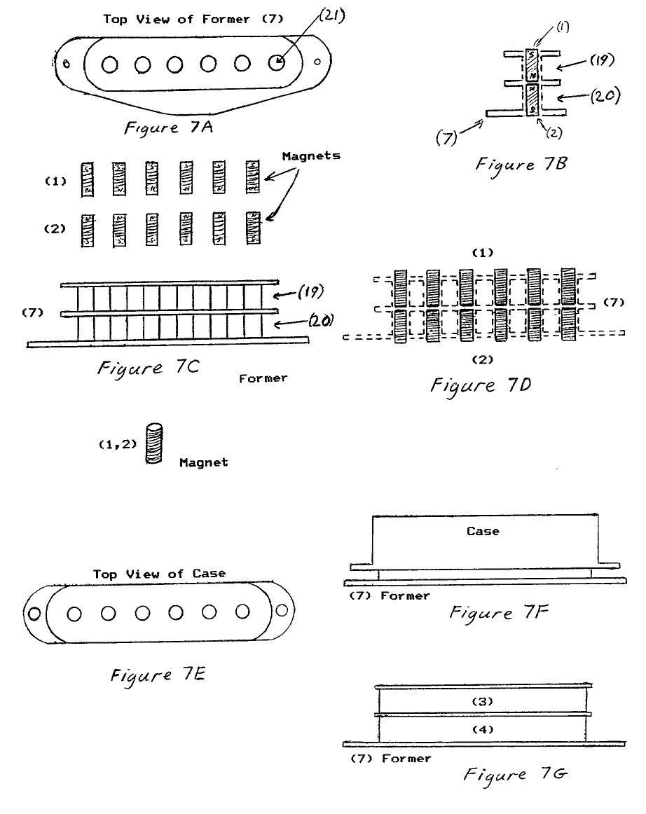

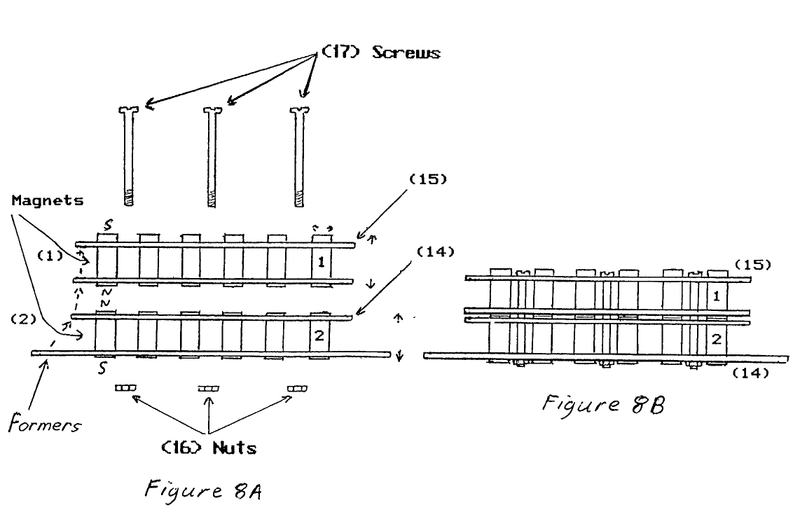

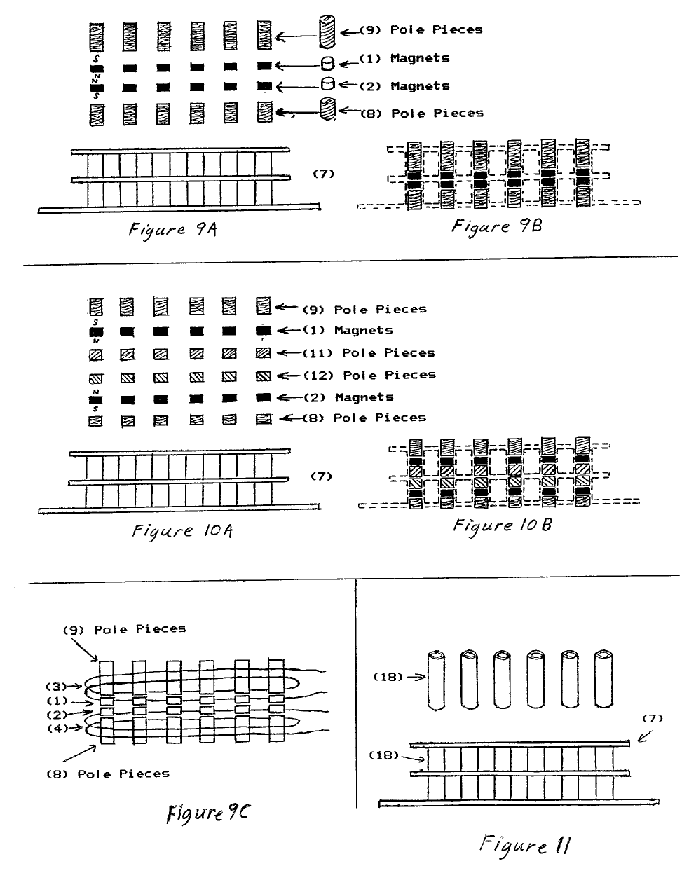

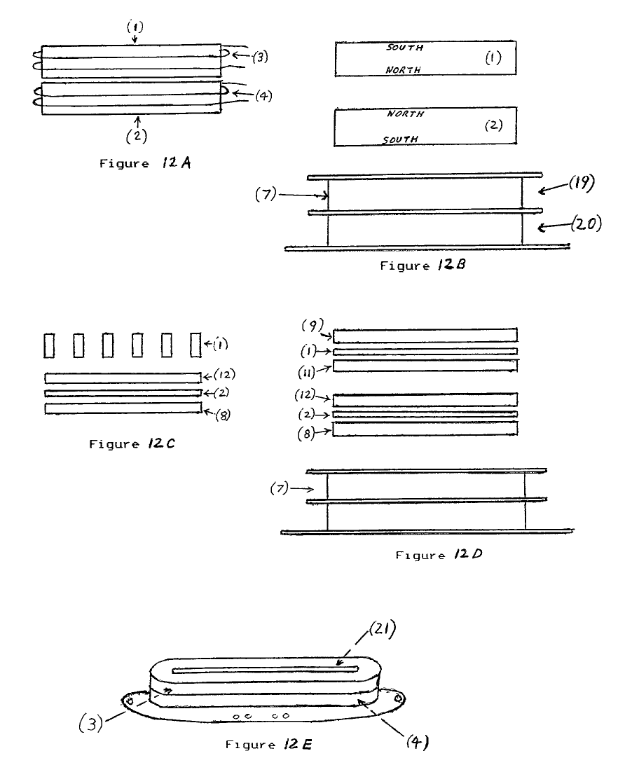

FIG. 9C, illustrates a technical type representation of the coils (3) & (4) around the magnets (1) & (2) plus pole pieces (9) & (8)

Drawings on page 10.

FIG. 11, illustrates a Former (7) wherein the tubular sections (18) of the former (7) are constructed with separate tubular members.

Drawings on page 11.

The FIGS. 12A to 12E, illustrates some variations of the invention.

FIG. 12A, illustrates a technical type representation of the coils (3) & (4) around the permanent magnet means (1) & (2) wherein the first permanent magnet means (1) contains just one magnet and the second permanent magnets means (2) contains just one magnet.

FIG. 12B, illustrates a side view of a former (7), with magnets (1) & (2) above.

FIG. 12C, illustrates two permanent magnet means (1) & (2) wherein the first permanent magnet means contains more than one magnet and the second permanent magnet means contains only one magnet and two pole pieces.

FIG. 12D, illustrates a fomer (7), with magnets (1) & (2) plus pole pieces (9), (11), (12) & (8) above.

FIG. 12E, illustrates a three dimensional image of a device wherein the first permanent magnet means contains only one magnet and the second permanent magnet means contains only one magnet.

Drawings on page 12.

FIGS. 13A to 13C, illustrates a string that is bent & shifted through the magnetic flux pattern.

The claims defining the invention are as follows:

1. An electromagnetic humbucker pick-up for stringed musical instruments comprising a first permanent magnet means on top of a second permanent magnet means, a first wire coil means around the first permanent magnet means, a second wire coil means around the second permanent magnet means, wherein the magnetic polarization of the first permanent magnet means opposes the magnetic polarization of the second permanent magnet means,
wherein the first permanent magnet means generates a first magnetic field and the second permanent magnet means generates a second magnetic field,
wherein the first wire coil means and the second wire coil means have a common axis perpendicular to a set of ferrous strings,
wherein both permanent magnet means is situated in a way that only the magnetic flux at the top of the first permanent magnet means reaches out to a set of ferrous strings,
wherein vibrating ferrous metal strings course a fluctuation in the first magnetic field that is relayed through to the second magnetic field and thus producing an alternating electric current in both wire coil means,
including a means of a former elongated in shape, having at least one hold in the top extending through to the bottom whereinto the said first permanent magnet means and the said second permanent magnet means are situated, the former having a upper cavity extending in a full circle around the sides of the upper half, whereinto the said first wire coil means is disposed, the former having a lower cavity extending in a full circle around the sides of the lower half, whereinto the said second wire coil means is disposed.

2. A electromagnetic humbucker pick-up for stringed musical instruments of claim 1 wherein the first permanent magnet means comprises a plural of magnets.

3. A electromagnet humbucker pick-up for stringed musical instruments of claims 1 wherein the second permanent magnet means comprises a plural of magnets.

4. A electromagnetic humbucker pick-up for stringed musical instruments of claims 1 wherein the first permanent magnet means comprises only one magnet.

5. A electromagnetic humbucker pick-up for stringed musical instruments of claims 1 wherein the second permanent magnet means comprises only one magnet.

6. A electromagnetic humbucker pick-up for stringed musical instruments as claimed in claims 2 to 5 wherein the permanent magnet means incorporate ferrous pole pieces.

7. A electromagnetic humbucker pick-up for stringed musical instruments as claimed in claims 2 to 5 or claim 6, wherein the first wire coil means and the second wire coil means comprise leads that are free to be wired in any format, in series, in parallel, out-of-phase with each other, in-phase with each other.

8. A electromagnetic humbucker pick-up for stringed musical instruments as claimed in claims 2 to 5 or claim 6, wherein the first wire coil means and the second wire coil means comprise leads that are pre-wired, out-of-phase with each other to EMF, in-phase with each other to string-signal, either in series or parallel.

9. A electromagnetic humbucker pick-up for stringed musical instruments as claimed in claims 7, wherein either or both wire coil means comprises a coil that is tapped or divided into a plural of coils.

10. A electromagnetic humbucker pick-up for stringed musical instruments as claimed in claim 7 or claim 8, wherein either or both wire coil means comprises a coil that is not tapped or divided into a plural of coils.

11. A electromagnetic humbucker pick-up for stringed musical instruments as claimed in any one of claims 7 to 8 or claim 6, wherein the first permanent magnet means comprises the same permeability as that comprised by the second permanent magnet means and the number of turns that is comprised by the first wire coil means is the same as the number of turns that is comprised by the second wire coil means.

12. A electromagnetic humbucker pick-up for stringed musical instruments as claimed in any one of claims 7 to 10 or claim 6, wherein the first permanent magnet means comprises a different permeability to that comprised by the second permanent magnet means, the number of turns that is comprised by the first wire coil means is different to the number of turns that is comprised by the second wire coil means, the first wire coil means comprises a gauge of wire that is different to the gauge of wire that is comprised by the second wire coil means.

13. A electromagnetic humbucker pick-up for stringed musical instruments as claimed in any one of claims 7 to 12, wherein active circuitry, is not required.

14. A electromagnetic humbucker pick-up for stringed musical instruments as claimed in any one of claims 7 to 12, wherein active circuitry, is provided.
